(19) United States
(12) Patent Application Publication
(10) Pub. No.: US 2024/0258902 A1
(43) Pub. Date: Aug. 1, 2024

(54) BALANCING STACKED CAPACITOR CONVERTERS

(71) Applicant: Apple Inc., Cupertino, CA (US)

(72) Inventors: Jie Lu, San Jose, CA (US); Ashish K Sahoo, Santa Clara, CA (US); Brandon Pierquet, San Francisco, CA (US); Anish Prasai, Santa Clara, CA (US)

(21) Appl. No.: 18/162,177

(22) Filed: Jan. 31, 2023

(51) Int. Cl. H02M 1/08; H02M 3/335; H02M 7/219

(52) U.S. Cl. CPC H02M 1/083; H02M 3/33573; H02M 7/219

(57) ABSTRACT

A power conversion system can include at least one stacked half bridge converter that further includes a first half bridge further comprising two switching devices in a half bridge configuration and a first capacitor coupled thereacross and a second half bridge further comprising two switching devices in a half bridge configuration and a second capacitor coupled thereacross. The at least one stacked half bridge converter can be disposed between an input of the power conversion system and an output of the power conversion system. The power conversion system can further include a transformer coupled to the at least one stacked half bridge converter by a blocking capacitor and control circuitry that operates the switching devices of the at least one stacked half bridge converter as a switched capacitor converter using the blocking capacitor as a flying capacitor to equalize charge between the first and second capacitors.

### BACKGROUND

Battery powered systems are ubiquitous and range from lower power/small battery systems such as personal electronic devices to higher power/larger battery systems such as electrified vehicles, grid storage, etc. For each of these applications, improved charger operation and efficiency are desired while reducing cost and complexity.

### SUMMARY

This disclosure relates to improved power conversion systems that incorporate stacked capacitor converters that may be applied in any of the applications described above. The stacked capacitor converters can be configured and operated to balance the stacked capacitors as described below.

A power conversion system can include at least one stacked half bridge converter that further includes a first half bridge further comprising two switching devices in a half bridge configuration and a first capacitor coupled thereacross and a second half bridge further comprising two switching devices in a half bridge configuration and a second capacitor coupled thereacross. The at least one stacked half bridge converter can be disposed between an input of the power conversion system and an output of the power conversion system. The power conversion system can further include a transformer coupled to the at least one stacked half bridge converter by a blocking capacitor and control circuitry that operates the switching devices of the at least one stacked half bridge converter as a switched capacitor converter using the blocking capacitor as a flying capacitor to equalize charge between the first and second capacitors.

The control circuitry can operate the switching devices of the at least one stacked half bridge converter as a switched capacitor converter by alternating between one mode including closing high side switches of the first and second half bridges and opening low side switches of the first and second half bridges and an additional mode including opening high side switches of the first and second half bridges and closing low side switches of the first and second half bridges.

The control circuitry can alternate between the one mode and the additional mode at a frequency selected to achieve zero voltage switching by virtue of resonance between a leakage inductance of the transformer with the flying capacitor. The at least one stacked half bridge converter can further include a first stacked half bridge converter coupled between an input of the power conversion system and the transformer and a second stacked half bridge converter coupled between the transformer and the battery. The control circuitry can operate the switching devices of the first stacked half bridge converter as the switched capacitor converter using the blocking capacitor as a flying capacitor to equalize charge between the first and second capacitors. The control circuitry can open high side switches of the second stacked half bridge converter and can close low side switches of the second stacked half bridge converter while operating the switching devices of the first stacked half bridge converter as the switched capacitor converter such that the one mode is a first mode and the additional mode is a second mode. The control circuitry can close high side switches of the second stacked half bridge converter and can open low side switches of the second stacked half bridge converter while operating the switching devices of the first stacked half bridge converter as the switched capacitor converter such that the one mode is a third mode and the additional mode is a fourth mode. The control circuitry can alternate between opening high side switches of the second stacked half bridge converter and closing low side switches of the second stacked half bridge converter while operating the switching devices of the first stacked half bridge converter as the switched capacitor converter such that the one mode is a first mode and the additional mode is a second mode and closing high side switches of the second stacked half bridge converter and opening low side switches of the second stacked half bridge converter while operating the switching devices of the first stacked half bridge converter as the switched capacitor converter such that the one mode is a third mode and the additional mode is a fourth mode. The control circuitry can alternate between opening high side switches of the second stacked half bridge converter and closing low side switches of the second stacked half bridge converter and closing high side switches of the second stacked half bridge converter and opening low side switches of the second stacked half bridge converter at a frequency equal to a frequency of switching between the one mode and the additional mode. The control circuitry can alternate between opening high side switches of the second stacked half bridge converter and closing low side switches of the second stacked half bridge converter and closing high side switches of the second stacked half bridge converter and opening low side switches of the second stacked half bridge converter at a frequency equal to one-half a frequency of switching between the one mode and the additional mode.

At least one stacked half bridge converter can be coupled between an input of the power conversion system and the transformer and can further include a full bridge converter coupled between the transformer and the battery. The control circuitry can open high side switches of the full bridge converter and closes low side switches of the full bridge converter while operating the switching devices of the stacked half bridge converter as the switched capacitor converter such that the one mode is a first mode and the additional mode is a second mode. The control circuitry can close high side switches of the full bridge converter and opens low side switches of the full bridge converter while operating the switching devices of the stacked half bridge converter as the switched capacitor converter such that the one mode is a third mode and the additional mode is a fourth mode. The control circuitry can alternate between opening high side switches of the full bridge converter and closing low side switches of the full bridge converter while operating the switching devices of the stacked half bridge converter as the switched capacitor converter such that the one mode is a first mode and the additional mode is a second mode and closing high side switches of the full bridge converter and opening low side switches of the full bridge converter while operating the switching devices of the stacked half bridge converter as the switched capacitor converter such that the one mode is a third mode and the additional mode is a fourth mode. The control circuitry can alternate between opening high side switches of the full bridge converter and closing low side switches of the full bridge converter and closing high side switches of the full bridge converter and opening low side switches of the full bridge converter at a frequency equal to a frequency of switching between the one mode and the additional mode. The control circuitry can alternate between opening high side switches of the full bridge converter and closing low side switches of the full bridge converter and closing high side switches of the full bridge converter and opening low side switches of the full bridge converter at a frequency equal to one-half a frequency of switching between the one mode and the additional mode.

An AC-DC power conversion system can include a first stacked half bridge converter coupled across an AC input of the AC-DC power conversion system, the first stacked half bridge converter further including: a first half bridge including two switching devices in a half bridge configuration and a first capacitor coupled thereacross and a second half bridge further comprising two switching devices in a half bridge configuration and a second capacitor coupled thereacross; a transformer having a primary winding coupled to the first stacked half bridge converter by a blocking capacitor and a secondary winding; a second stacked half bridge converter coupled between the secondary winding of the transformer and an output of the AC-DC power conversion system, the second stacked half bridge converter further including: a first half bridge further comprising two switching devices in a half bridge configuration and a first capacitor coupled thereacross and a second half bridge further comprising two switching devices in a half bridge configuration and a second capacitor coupled thereacross; and control circuitry that operates the switching devices of the first and second stacked half bridge converters so that the first stacked half bridge converter acts a flying capacitor to equalize charge between the first and second capacitors using the blocking capacitor as a flying capacitor to equalize charge between the first and second capacitors.

The control circuitry can operate the switching devices of the first and second stacked half bridge converters to also equalize charge between third and fourth capacitors using the blocking capacitor as a flying capacitor. The control circuitry can operate the switching devices of the at least one stacked half bridge converter as a switched capacitor converter by alternating between one mode including closing high side switches of the first and second half bridges and opening low side switches of the first and second half bridges of the first stacked half bridge converter; and an additional mode including opening high side switches of the first and second half bridges and closing low side switches of the first and second half bridges of the first stacked half bridge converter. The control circuitry can alternate between the one mode and the additional mode at a frequency selected to achieve zero voltage switching by virtue of resonance between a leakage inductance of the transformer with the flying capacitor. The control circuitry can open high side switches of the second stacked half bridge converter and can close low side switches of the second stacked half bridge converter while operating the switching devices of the first stacked half bridge converter as the switched capacitor converter such that the one mode is a first mode and the additional mode is a second mode. The control circuitry can close high side switches of the second stacked half bridge converter and can open low side switches of the second stacked half bridge converter while operating the switching devices of the first stacked half bridge converter as the switched capacitor converter such that the one mode is a third mode and the additional mode is a fourth mode.

A DC-DC power conversion system can include a stacked half bridge converter coupled across a DC input of the DC-DC power conversion system, the stacked half bridge converter further comprising: a first half bridge including two switching devices in a half bridge configuration and a first capacitor coupled thereacross and a second half bridge further comprising two switching devices in a half bridge configuration and a second capacitor coupled thereacross; a transformer having a primary winding coupled to the stacked half bridge converter by a blocking capacitor and a secondary winding; a full bridge converter coupled between the secondary winding of the transformer and an output of the DC-DC power conversion system, the full bridge converter comprising four switching devices in a full bridge configuration; and control circuitry that operates the switching devices of the stacked half bridge converter and the full bridge converter so that the stacked half bridge converter acts a switched capacitor converter to equalize charge between the first and second capacitors.

The control circuitry can operate the switching devices of the stacked half bridge converter as a switched capacitor converter by alternating between one mode including closing high side switches of the first and second half bridges and opening low side switches of the first and second half bridges and an additional mode including opening high side switches of the first and second half bridges and closing low side switches of the first and second half bridges. The control circuitry can alternate between the one mode and the additional mode at a frequency selected to achieve zero voltage switching by virtue of resonance between a leakage inductance of the transformer with the flying capacitor. The control circuitry can alternate between opening high side switches of the full bridge converter and closing low side switches of the full bridge converter while operating the switching devices of the stacked half bridge converter as the switched capacitor converter such that the one mode is a first mode and the additional mode is a second mode and closing high side switches of the full bridge converter and opening low side switches of the full bridge converter while operating the switching devices of the stacked half bridge converter as the switched capacitor converter such that the one mode is a third mode and the additional mode is a fourth mode.

### BRIEF DESCRIPTION OF THE DRAWINGS

FIG. 1 illustrates a stacked capacitor AC-DC converter.

FIG. 2 illustrates a stacked capacitor DC-DC converter.

FIG. 3A illustrates an equivalent circuit of a stacked capacitor AC-DC converter operated as a switched capacitor balancer.

FIG. 3B illustrates control circuitry for a stacked capacitor AC-DC converter operated as a switched capacitor balancer.

FIGS. 4A-4B illustrate first and second switching modes of a stacked capacitor AC-DC converter operated as a switched capacitor balancer.

FIG. 5 illustrates various waveforms of a stacked capacitor AC-DC converter operated as a switched capacitor balancer using the first and second switching modes.

FIGS. 6A-6B illustrate third and fourth switching modes of a stacked capacitor AC-DC converter operated as a switched capacitor balancer.

FIGS. 7A-7B illustrate various waveforms of a stacked capacitor AC-DC converter operated as a switched capacitor balancer using the first, second, third, and fourth switching modes.

FIG. 8A illustrates an equivalent circuit of a stacked capacitor DC-DC converter operated as a switched capacitor balancer.

FIG. 8B illustrates control circuitry for a stacked capacitor DC-DC converter operated as a switched capacitor balancer.

FIGS. 9A-9B illustrate first and second switching modes of a stacked capacitor DC-DC converter operated as a switched capacitor balancer.

FIG. 10 illustrates various waveforms of a stacked capacitor DC-DC converter operated as a switched capacitor balancer using the first and second switching modes.

FIGS. 11A-11B illustrate third and fourth switching modes of a stacked capacitor AC-DC converter operated as a switched capacitor balancer.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

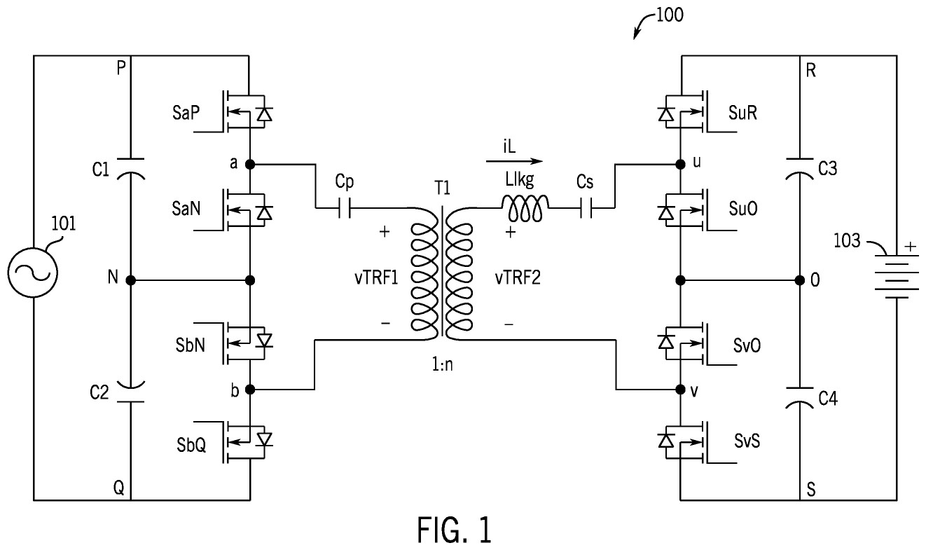

FIG. 1 illustrates a stacked capacitor AC-DC converter 100. Such a converter could be used in a variety of applications to charge a battery 103 from an AC source 101. As but one non-limiting example, stacked capacitor AC-DC converter 100 could be a grid storage system, with

AC source 101 being the AC power grid, while battery 103 could be a high voltage (e.g., 400V, 800V, etc.) storage battery. As another non-limiting example, stacked capacitor AC-DC converter 100 could be incorporated into an electrified vehicle, with AC source 101 being the AC grid (for a plug-in electrified vehicle) or an AC generator (for a hybrid vehicle) with battery 103 being the traction battery for such a system. The topology of FIG. 1 could also be used in a wide variety of other applications, and thus the foregoing should be considered as mere examples.

In at least some applications, it may be desirable to use a “stacked” topology to be able to use devices having lower voltage ratings on higher voltage systems. For example, AC-DC converter 100 can include a stacked half bridge inverter made up of a first half bridge (in turn made up of switches SaP and SaN) and a second half bridge (in turn made up of switches SbN and SbQ). Stacked input capacitors C1 and C2 can be provided across the inputs of the respective half bridges. The half bridges can be coupled across the AC source 101 (between terminals P and Q) and can be coupled together at a neutral N. The stacked half bridge inverter can convert the AC power from AC source 101 into AC power having different characteristics (voltage, frequency, etc.) by controlled operation of the switches SaP, SaN, SbN, and SbQ. To that end, stacked capacitor AC-DC converter 100 can include control circuitry (discussed in greater detail below) that controls switching of these devices to produce the desired voltage at stacked half bridge output terminals a, b, for example using pulse width modulation (PWM).

As another example of a stacked converter topology, AC-DC converter 100 can include a stacked half bridge rectifier made up of a first half bridge (in turn made up of switches SuR and SuO) and a second half bridge (in turn made up of switches SvO and SvS). Stacked output capacitors C3 and C4 can be provided across the outputs of the respective half bridges. The half bridges have their switch nodes u, v coupled to the secondary winding of transformer T1, and are coupled in series across battery 103 (between nodes R, S) and are coupled together at a neutral O. The stacked half bridge rectifier can convert the AC power from transformer T1 into DC power suitable for charging battery 103 by controlled operation of the switches SuR, SuO, SvO, and SvS. To that end, stacked capacitor AC-DC converter 100 can include control circuitry (discussed in greater detail below) that controls switching of these devices to produce the desired voltage at terminals R, S, for example using pulse width modulation (PWM).

The voltage produced by the stacked half bridge inverter can be provided to a transformer T1, which can have any desired turns ratio 1: n allowing for the voltage supplied to the secondary side to be increased or decreased according to this ratio. The stacked half bridge inverter can be coupled to the primary winding of transformer T1 by a blocking capacitor Cp. Similarly, the secondary winding of transformer T1 can be coupled to the stacked half bridge rectifier (discussed above) by a blocking capacitor Cs. Also represented in FIG. 1 is the leakage inductance Llkg of transformer T1. This leakage inductance may be an inherent property of the transformer construction and need not be a discrete inductor. In at least some embodiments, the physical construction of transformer T1 can be chosen to provide a desired leakage inductance value, and/or other circuit components may be selected to provide the desired interaction with this leakage inductance. However, in some applications, an additional discrete inductor could be provided in series with one or the other transformer winding to provide the desired inductance. Also pertinent to the discussion below is the voltage applied to the transformer primary winding vTRF1, the voltage appearing at the transformer secondary winding vTRF2, and the transformer secondary winding/leakage inductance current iL, each depicted in FIG. 1. These values are discussed in greater detail below, along with further operational details of the stacked capacitor AC-DC converter 100.

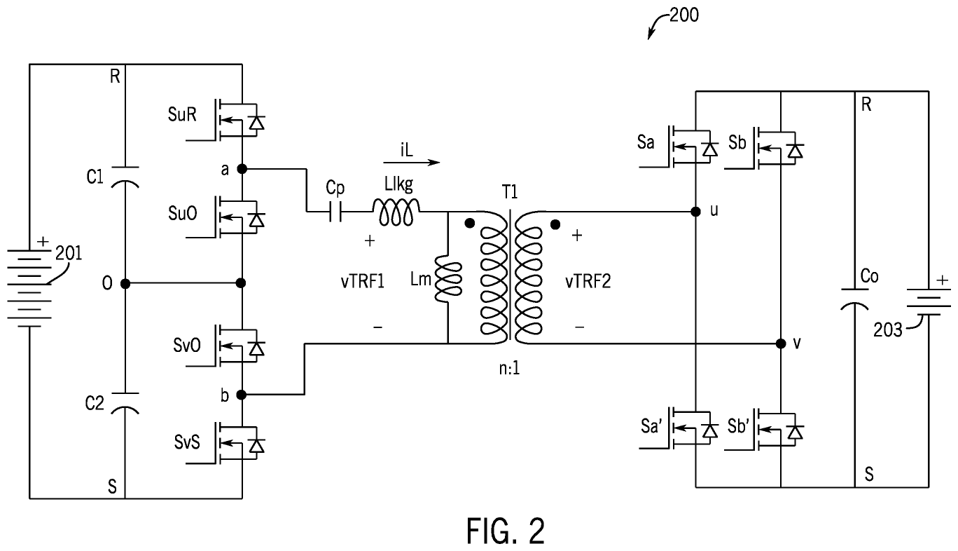

FIG. 2 illustrates a stacked capacitor DC-DC converter 200. Such a converter could be used in a variety of applications to charge a battery 203 from another battery 201. As but one non-limiting example, stacked capacitor DC-DC converter 200 could be part of an electrified vehicle, with battery 201 being a high(er) voltage traction battery and battery 203 being a low(er) voltage battery for ancillary vehicle systems. As another non-limiting example, stacked capacitor DC-DC converter 200 could be part of system such as a battery bank or portable electronic device (such as a laptop computer, tablet computer, mobile phone, etc.) that can be used to charge another portable electronic device or an accessory for such devices (earphones, stylus, etc.). The topology of FIG. 2 could also be used in a wide variety of other applications, and thus the foregoing should be considered as mere examples.

In at least some applications, it may be desirable to use a “stacked” topology to be able to use devices having lower voltage ratings on higher voltage systems. For example, DC-DC converter 200 can include a stacked half bridge inverter made up of a first half bridge (in turn made up of switches SuR and SuO) and a second half bridge (in turn made up of switches SvO and SvS).

Stacked input capacitors C1 and C2 can be provided across the inputs of the respective half bridges.

The half bridges can be coupled across the high voltage battery 201 (between terminals R and S) and can be coupled together at a neutral O. The stacked half bridge inverter can convert the DC power from high voltage battery 201 into AC power having different characteristics (voltage, frequency, etc.) by controlled operation of the switches SuR, SuO, SvO, and SvS. To that end, stacked capacitor DC-DC converter 200 can include control circuitry (discussed in greater detail below) that controls switching of these devices to produce the desired voltage at stacked half bridge output terminals a, b, for example using pulse width modulation (PWM).

DC-DC converter 200 can also include a full bridge rectifier made up of switches Sa, Sa′, Sb, and Sb′. The full bridge rectifier can have its inputs terminals u, v (corresponding to the switch nodes of the respective switch pairs Sa/Sa′ and Sb/Sb′), with its output terminals coupled to low voltage battery 203 terminals R, S. An output capacitor Co may also be provided in parallel with low voltage battery 203. The full bridge rectifier can convert the AC power from transformer T1 into DC power suitable for charging battery 203 by controlled operation of the switches Sa/Sa′ and Sb/Sb′. To that end, stacked capacitor DC-DC converter 200 can include control circuitry (discussed in greater detail below) that controls switching of these devices to produce the desired voltage at terminals R, S, for example using pulse width modulation (PWM).

The voltage produced by the stacked half bridge inverter can be provided to a transformer T1, which can have any desired turns ratio n: 1 allowing for the voltage supplied to the secondary side to be increased or decreased according to this ratio. The stacked half bridge inverter can be coupled to the primary winding of transformer T1 by a blocking capacitor Cp. Also represented in FIG. 2 is the leakage inductance Llkg of transformer T1. This leakage inductance may be an inherent property of the transformer construction and need not be a discrete inductor. In at least some embodiments, the physical construction of transformer T1 can be chosen to provide a desired leakage inductance value, and/or other circuit components may be selected to provide the desired interaction with this leakage inductance. However, in some applications, an additional discrete inductor could be provided in series with one or the other transformer winding to provide the desired inductance. Also pertinent to the discussion below is the voltage applied to the transformer primary winding vTRF1, the voltage appearing at the transformer secondary winding vTRF2, and the transformer secondary winding/leakage inductance current iL, each depicted in FIG. 1. These values are discussed in greater detail below, along with further operational details of the stacked capacitor DC-DC converter 200.

For each of the above-described topologies, balancing the voltages of the stacked capacitors (e.g., input capacitors C1/C2 and/or output capacitors C3/C4) can be a challenge. This may particularly be the case when the respective stacked half bridge circuits are operated in burst mode. Burst mode operation may be used in relatively lower power states to allow for optimal switching (e.g., switching with a desired timing, frequency, soft switching, etc.) during so-called “burst” or “burst on” intervals with switching temporarily stopped during “burst off” intervals. The result can be higher power transfer during the burst on intervals with no power transfer during the burst off intervals that averages out to the required (relatively low) power level. Another result can be improved operation, e.g., because of reduced switching losses. During the burst on intervals, balancing the capacitors can be achieved by injecting current into the mid-point/neutral point (N, O) of the respective stacked half bridges. However, with normal burst mode operation, in which switching is disabled during the burst off periods, such balancing is not possible. Described below are various approaches to using the respective stacked half bridges as switched capacitor balancers to equalize the stacked capacitor charge.

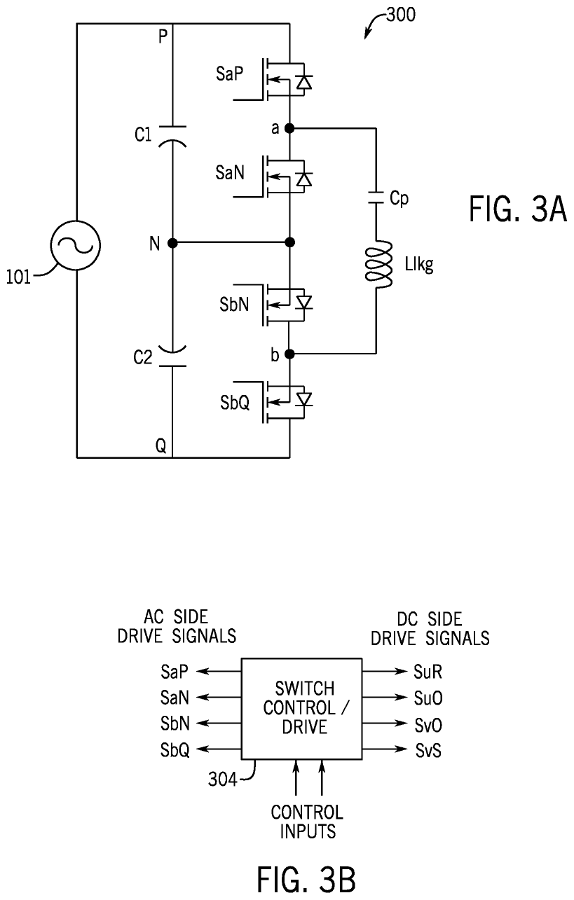

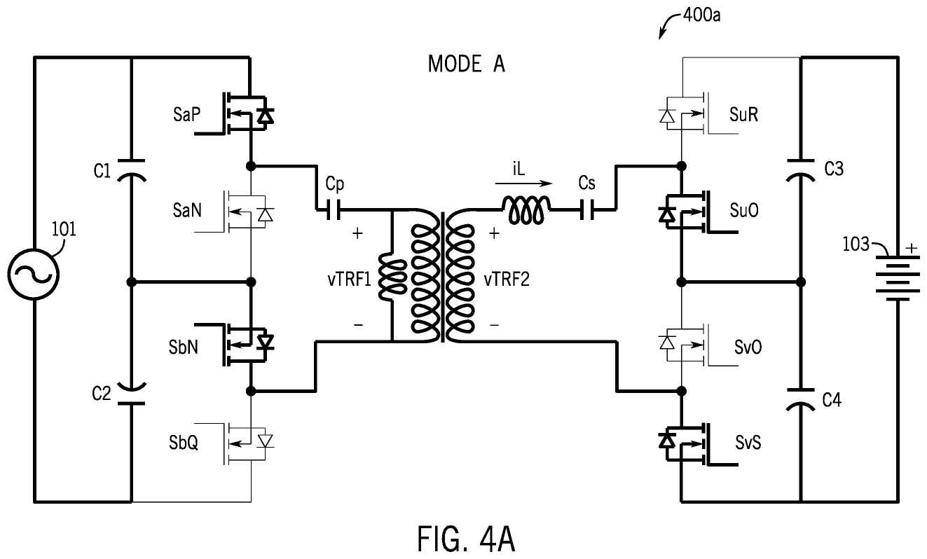

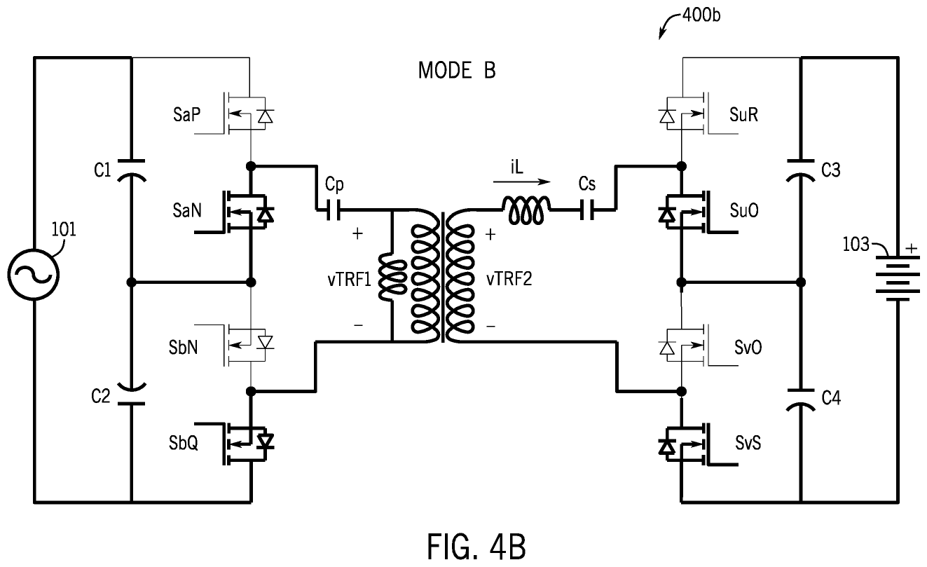

FIG. 3A illustrates an equivalent circuit of a stacked capacitor AC-DC converter inverter stage operated as a switched capacitor balancer. More specifically, inverter switching devices SaP, SaN, SbN, and SbQ (cf. FIG. 1) can be operated by control circuitry 304 (FIG. 3B) to alternately couple blocking capacitor Cp in parallel with the respective input capacitors C1/C2 using various switching modes described below with reference to FIGS. 4A/4B and 6A/6B. Blocking capacitor Cp thus acts as the flying capacitor of the switched capacitor balancer. The result of this operation is equalizing charge between the input capacitors C1/C2.

FIG. 3B illustrates control circuitry 304 for a stacked capacitor AC-DC converter 100 operated as a switched capacitor balancer. Control circuitry 304 can be implemented using any suitable combination of analog, digital, or programmable circuitry, implementing such functions as error amplifiers, comparators, logic gates, delays, storage, programmable functionality, microcontrollers, microprocessors, etc. This circuitry can be implemented using any suitable combination of discrete circuit elements, integrated circuits, etc. Control circuitry 304 can receive a variety of inputs, including indications whether the system is connected to an AC source, battery state of charge, and voltage/current signals, such as supplied voltages and/or supplied or available input currents; output voltages and supplied, required, or desired output currents; and one or more intermediate voltages, currents, or other signals (temperature, etc.). Although described as a single controller, control circuitry 304 could be implemented as multiple controllers each providing certain functionality. In such cases, communication between the various control circuits/controllers can be provided as necessary or desirable to provide the desired overall operation and/or the various separate control circuits can operate independently to the extent possible or desirable.

Control circuitry 304 can also implement one or more control loops and/or program logic to generate the signals needed to control various components of the system. For example, AC side drive signals may be provided to control the operation of switches SaP, SaN, SbN, and SbQ depending on the operating mode and other parameters. For example, when charging from an AC source these switches can be operated to provide a desired voltage to transformer T1 corresponding to a desired battery charging voltage. Control circuitry 304 can also implement burst mode control in light load conditions including balancing as described in greater detail below.

Likewise, control circuitry 304 can also provide DC side control/drive signals to control the operation of switches SuR, SuO, SvO, and SvS depending on the operating mode and other parameters. For example, when charging from an AC source, these switches can be operated as an active rectifier to produce a DC charging voltage from the AC voltage appearing across the secondary winding of transformer T1. Control circuitry 304 can also implement burst mode charging and associated balancing as described in greater detail below.

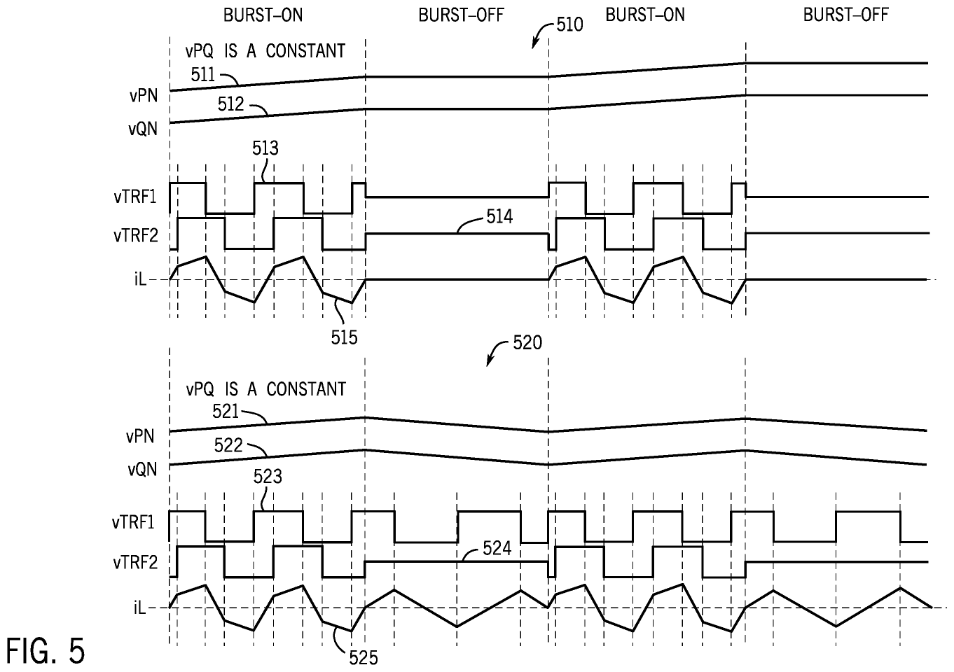

FIGS. 4A-4B illustrate first and second switching modes of a stacked capacitor AC-DC converter operated as a switched capacitor balancer. More specifically, FIG. 4A illustrates a first switching mode (Mode A) 400a, and FIG. 4B illustrates a second switching mode (Mode B) 400b. In both Mode A 400a and Mode B, the low side switches SuO and SvS of the DC side half bridges are turned on. This connects the equivalent (reflected) blocking capacitance Cs and leakage inductance Llkg across the AC side stacked half-bridge. As a result, the DC side blocking capacitance (Cs) voltage cancels out the voltage across the lower half-bridge decoupling capacitor (C4) to result in net zero voltage on secondary/DC side of the transformer. This results in the inverted switched capacitor topology described above with respect to FIG. 3A. In Mode A, the high side switches SaP and SbN of the respective AC side half bridges are turned on, while the low side switches (SaN, SbQ) are turned off. In Mode B, the low side switches SaN, SbQ of the AC half bridges are turned on while the high side switches SaP, SbN are turned off. Thus, the AC side half bridges are both operated with synchronized and complementary duty cycles. Alternating between switching Mode A and Mode B with a fixed frequency enables balancing the input stacked capacitors C1, C2 as explained in greater detail with respect to FIG. 5. This alternation can be considered a first switching sequence (Seq1) corresponding to alternation between Mode A and Mode B (ABABAB), which can also be denoted as Seq1: ABABAB.

FIG. 5 illustrates various waveforms of a stacked capacitor AC-DC converter operated as a switched capacitor balancer using the first and second switching modes. Upper plot 510 depicts various voltages and currents for burst mode operation in which switching is disabled during the burst off periods. Trace 511 depicts the voltage vPN between nodes P and N, i.e., the voltage across input capacitor C1. Trace 512 depicts the voltage vQN between nodes Q and N, i.e., the voltage across input capacitor C2. The difference between these signals (vPN-vQN) is a constant corresponding to the AC input voltage. In the illustrated operating sequence, the capacitors become increasingly unbalanced during each burst on interval, represented by the increase in each voltage vPN, vQN, while the unbalance remains constant, but does not decrease during the burst off intervals. This unbalance situation can be characterized by a shifting midpoint voltage and can be exacerbated by operating conditions in which the burst on intervals are short (e.g., due to very light loading) and/or as a result of hard switching events.

Trace 513 depicts vTRF1, the voltage applied to the primary winding of the transformer. This voltage alternates between a positive value and a negative value during the burst on periods, corresponding to the commutation of the respective inverter switches. During the burst off periods, vTRF1 is zero (when switching is disabled). Trace 514 depicts vTRF2, the voltage across the secondary winding of the transformer. This voltage, induced by vTRF1, thus also alternates between a positive and a negative value during the burst on periods. During the burst off periods, vTRF is zero (when switching is disabled). Finally, trace 515 depicts current iL (through the leakage inductance Llkg) which is quasi-sinusoidal during the burst on intervals and zero during the burst off intervals (when switching is disabled).

Lower plot 520 depicts various voltages and currents for burst mode operation in which switching as described above with respect to FIGS. 4A-4B is employed during the burst off periods. Trace 521 depicts the voltage vPN between nodes P and N, i.e., the voltage across input capacitor C1. Trace 522 depicts the voltage vQN between nodes Q and N, i.e., the voltage across input capacitor C2. The difference between these signals (vPN-vQN) is a constant corresponding to the AC input voltage. In the illustrated operating sequence, the capacitors become increasingly unbalanced during each burst on interval, represented by the increase in each voltage vPN, vQN, while the unbalance decreases during the burst off intervals. This is because of the alternation between switching modes A and B as described above, which serves to equalize the input capacitor (C1/C2) voltages (vPN/vQN) by virtue of the flying capacitor operation transferring charge (voltage) from the higher voltage (charge) capacitor to the lower voltage (charge) capacitor via the flying capacitor (blocking capacitor Cp). Additionally, control circuitry 304 can achieve soft switching of the AC side switches in equalization mode by suitable control/regulation of the switching frequency with respect to the resonance between flying/blocking capacitor Cp and leakage inductance Llkg.

Trace 523 depicts vTRF1, the voltage applied to the primary winding of the transformer. This voltage alternates between a positive value and a negative value during the burst on periods, corresponding to the commutation of the respective inverter switches. During the burst off periods, this voltage continues to alternate between positive and negative values by virtue of the control circuitry 304 continuing to operate the switches, alternating between Modes A and B as described above. Thus, switching is no longer disabled during the burst off mode. Trace 524 depicts vTRF2, the voltage across the secondary winding of the transformer. This voltage, induced by vTRF1, thus also alternates between a positive and a negative value during the burst on periods. During the burst off periods, vTRF is again zero because the DC side blocking capacitance (Cs) voltage cancels out the voltage across the lower half-bridge decoupling capacitor (C4), as described above with respect to FIGS. 4A/4B. Finally, trace 525 depicts current iL (through the leakage inductance Llkg) which is quasi-sinusoidal during the burst on intervals. During the burst off intervals, current iL is again quasi-sinusoidal, although with a DC offset corresponding to the charge transfer between the input capacitors caused by the equalizing operation.

One advantage of the above-described operation can be that closed-loop control may not be needed to balance the AC side input capacitors (C1/C2). Control circuitry 304 can simply run the described pulse sequence during burst-off period. Another advantage can be that the converter can behave like a heater during burst-off period. This can be achieved by controlling switching frequency during the burst off period to achieve a desired balancing current amplitude, and thus a desired degree of heat generation. This may be advantageous in applications that require operation in relatively low temperatures, where the generated heat can be used to maintain a desired battery temperature higher than the ambient environment; for cabin heating in an electrified vehicle; or for other applications where additional heat may be desired. Relatedly, the time-constant of the balance transition (i.e., the speed with which the balancing occurs) can also be controlled by controlling the switching frequency. During the burst off period, a 50% duty cycle between the switching modes can be used to maintain the flying/blocking capacitor (Cp) voltage at 50% of the input voltage. This can also allow smooth transitions to the burst on mode. When required power is 0 W (i.e., there is no burst on period, or the entire time is a burst off period) different duty cycles between the switching modes can be employed.

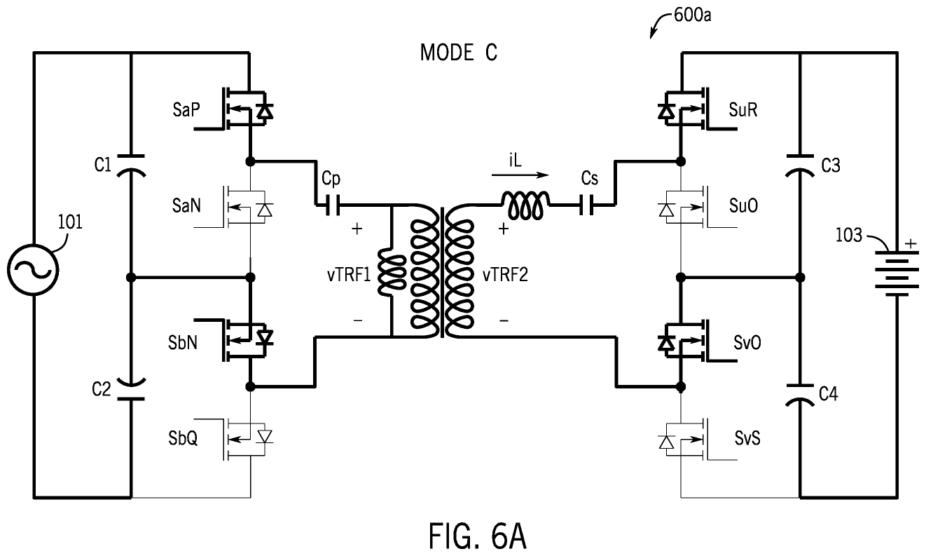

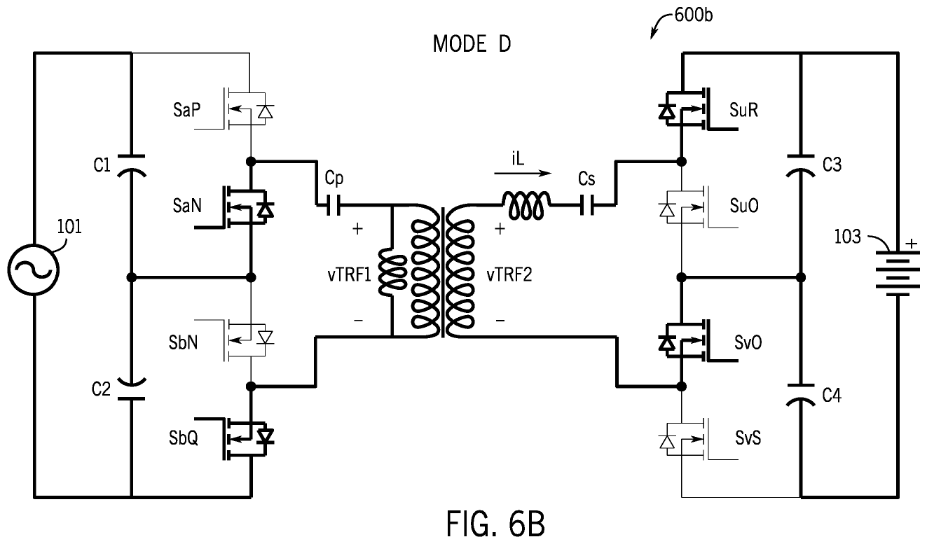

FIGS. 6A-6B illustrate alternate third and fourth switching modes of a stacked capacitor AC-DC converter operated as a switched capacitor balancer. More specifically, FIG. 6A illustrates a third switching mode (Mode C) 600c, and FIG. 6B illustrates a second switching mode (Mode D) 600d. These alternate switching modes may be used as an alternative to first Mode A and second Mode B to achieve input balancing. Alternatively, they can be used in conjunction with Modes A and B to also balance the output capacitors C3/C4 as described in greater detail below. In both Mode C 400c and Mode D 400d, the high side switches SuR and SvO of the DC side half bridges are turned on. This connects the equivalent (reflected) blocking capacitance Cs and leakage inductance Llkg across the AC side stacked half-bridge. As a result, the DC side blocking capacitance (Cs) voltage cancels out the voltage across the upper half-bridge decoupling capacitor (C3) to result in net zero voltage on secondary/DC side of the transformer. This results in the inverted switched capacitor topology described above with respect to FIG. 3A. In Mode C, the high side switches SaP and SbN of the respective AC side half bridges are turned on, while the low side switches (SaN, SbQ) are turned off (corresponding to Mode A, discussed above). In Mode B, the low side switches SaN, SbQ of the AC half bridges are turned on while the high side switches SaP, SbN are turned off (corresponding to Mode B, discussed above). Thus, the AC side half bridges are both operated with synchronized and complementary duty cycles. Alternating between switching Mode C and Mode D with a fixed frequency enables balancing the input stacked capacitors C1, C2 substantially as explained above with respect to FIG. 5 describing Modes A and B. This alternation can be considered a first switching sequence (Seq2) corresponding to alternation between Mode C and Mode D (CDCDCD), which can also be denoted as Seq2: CDCDCD.

Alternatively, switching sequences can be employed that alternate among Modes A, B, C, and D. In other words, the switching sequence can alternate between DC side switches SuO and SvS being constantly on (Modes C/D) and DC side switches SuR and SvO being constantly on (Modes A/B). The frequency of alternating between states on the DC side can be equal to or lower than the switching frequency of the AC side. Such switching sequences can be beneficial when high side switches do not have dedicated gate drive isolated power supplies and bootstrapping is used (which may require periodically refreshing the high side). Another benefit can be allowing losses and thermal performance to be balanced for all the devices. One example of such a switching sequence (Seq3) is one in which the DC side alternation occurs at the same frequency as the AC side switching. Thus, Seq3: ADCBADCB. An alternative switching sequence (Seq4) is one in which the DC side alternation occurs at one-half the frequency of the AC side switching. Thus, Seq4: ABCDABCD.

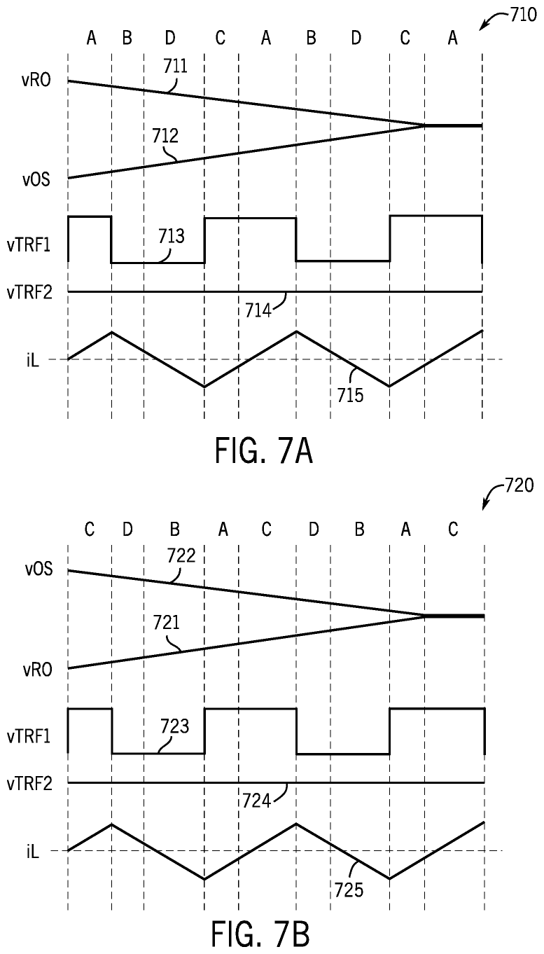

The switching sequences described above with respect to FIGS. 6A-6B can be used to balance the input capacitors C1/C2 substantially as described above with respect to FIG. 5. FIGS. 7A-7B illustrate various waveforms of a stacked capacitor AC-DC converter operated as a switched capacitor balancer using the first, second, third, and fourth switching modes to balance the DC side capacitors C3/C4. FIG. 7A depicts a plot 710 depicting various voltages and currents for a burst mode disabled period with emphasis on DC side balancing. Plot 710 corresponds to a switching sequence Seq6: ABDCABDC. Trace 711 depicts the voltage vRO between nodes R and O, i.e., the voltage across output capacitor C3. Trace 712 depicts the voltage vOS between nodes O and S, i.e., the voltage across output capacitor C4. The difference between these signals (vRO-vOS) corresponds to the imbalance between the output voltages, with a zero value indicating equal (balanced) capacitor voltages. In the illustrated operating sequence, the capacitors become increasingly balanced during the burst off interval, represented by the decrease in voltage vRO and the increase in voltage vOS. Trace 713 depicts vTRF1, the voltage applied to the primary winding of the transformer. This voltage alternates between a positive value and a negative value. Trace 714 depicts vTRF2, the voltage across the secondary winding of the transformer. This voltage remains constant during the burst off interval. Finally, trace 715 depicts current iL (through the leakage inductance Llkg) which is triangular in shape.

FIG. 7B depicts a plot 720 depicting various voltages and currents for a burst mode disabled period with emphasis on DC side balancing. Plot 720 corresponds to a switching sequence Seq7: CDBACDBA. Trace 721 depicts the voltage vRO between nodes R and O, i.e., the voltage across output capacitor C3. Trace 722 depicts the voltage vOS between nodes O and S, i.e., the voltage across output capacitor C4. The difference between these signals (vRO-vOS) corresponds to the imbalance between the output voltages, with a zero value indicating equal (balanced) capacitor voltages. In the illustrated operating sequence, the capacitors become increasingly balanced during the burst off interval, represented by the decrease in voltage vRO and the increase in voltage vOS. Trace 723 depicts vTRF1, the voltage applied to the primary winding of the transformer. This voltage alternates between a positive value and a negative value. Trace 724 depicts vTRF2, the voltage across the secondary winding of the transformer. This voltage remains constant during the burst off interval. Finally, trace 725 depicts current iL (through the leakage inductance Llkg) which is triangular in shape.

As can be seen from FIGS. 7A-7B, both AC and DC side buses can be balanced during burst-off period by applying certain sequences. Sequence 5 (Seq5: ABDCABDC) can increase vOS and hence decrease vRO. Sequence 6 (Seq6: CDBACDBA) can decrease vOS and hence increase vRO. In either case, once the DC side busses are balanced, switching can transition to another sequence, as described above (e.g., Seq1, Seq2, Seq3, or Seq4, as described above). Additionally, the AC-side bus is balanced substantially as described above with respect to FIG. 5. However, closed-loop control may be needed to balance the DC-side buses. For Seq5: ABDCABDC, the time of B-to-D and C-to-A transitions can be designed to achieve ZVS of DC-side switches. Similarly, for Seq6: CDBACDBA, the time of D-to-B and A-to-C transitions are designed to achieve ZVS of DC-side switches.

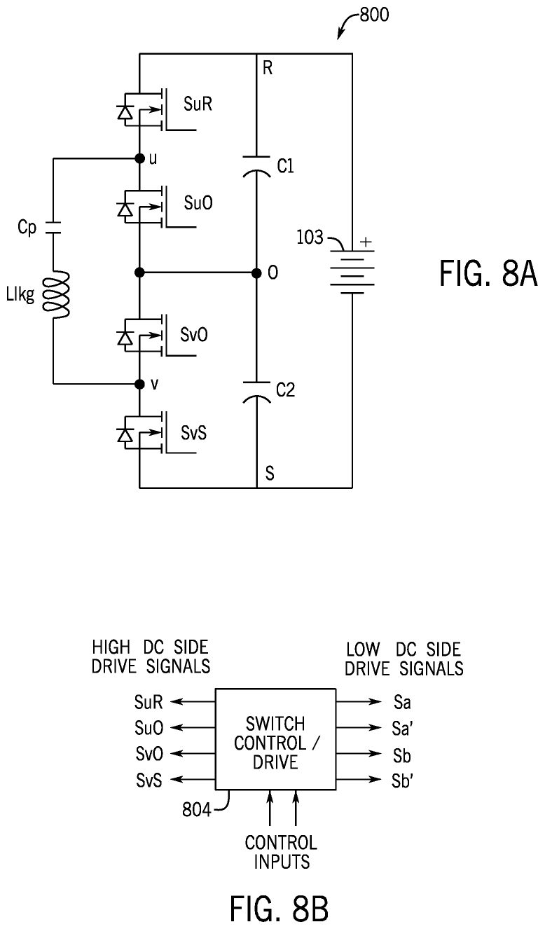

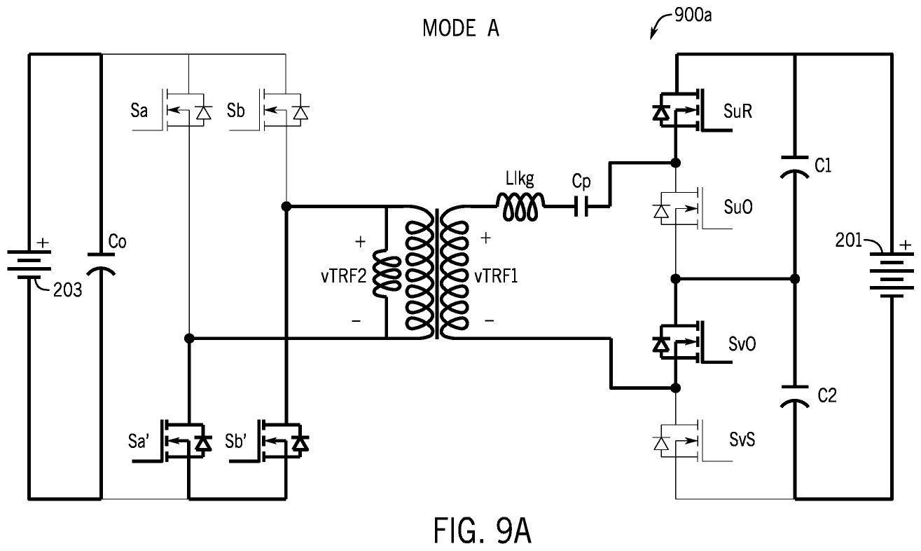

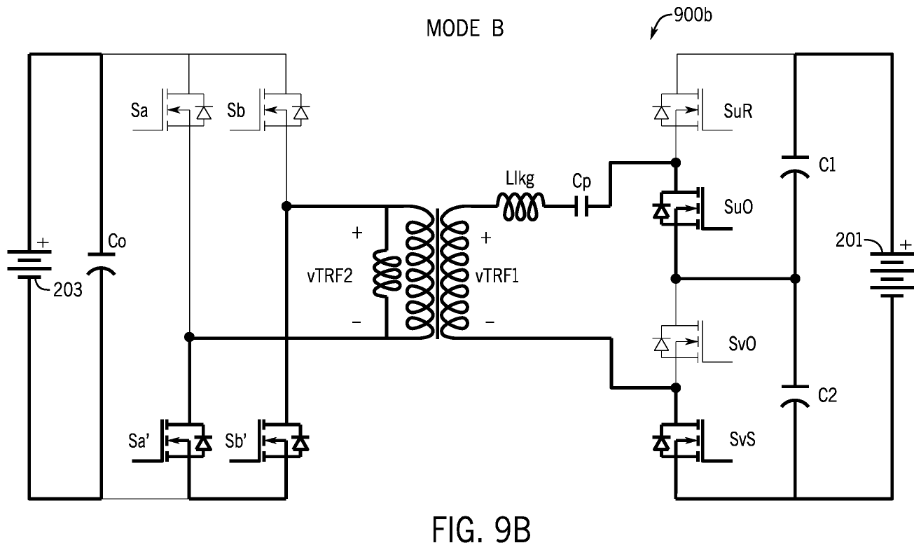

FIG. 8A illustrates an equivalent circuit of a stacked capacitor DC-DC converter operated as a switched capacitor balancer. More specifically, inverter switching devices SuR, SuO, SvO, SvS (cf. FIG. 2) can be operated by control circuitry 804 (FIG. 8B) to alternately couple blocking capacitor Cs in parallel with the respective input capacitors C1/C2 using various switching modes described below with reference to FIGS. 9A/9B and 11A/11B. Blocking capacitor Cs thus acts as the flying capacitor of the switched capacitor balancer. The result of this operation is equalizing charge between the input capacitors C1/C2.

FIG. 8B illustrates control circuitry for a stacked capacitor DC-DC converter operated as a switched capacitor balancer. Control circuitry 804 can be implemented using any suitable combination of analog, digital, or programmable circuitry, implementing such functions as error amplifiers, comparators, logic gates, delays, storage, programmable functionality, microcontrollers, microprocessors, etc. This circuitry can be implemented using any suitable combination of discrete circuit elements, integrated circuits, etc. Control circuitry 804 can receive a variety of inputs, including battery state of charge, and voltage/current signals, such as supplied voltages and/or supplied or available input currents; output voltages and supplied, required, or desired output currents; and one or more intermediate voltages, currents, or other signals (temperature, etc.). Although described as a single controller, control circuitry 804 could be implemented as multiple controllers each providing certain functionality. In such cases, communication between the various control circuits/controllers can be provided as necessary or desirable to provide the desired overall operation and/or the various separate control circuits can operate independently to the extent possible or desirable.

Control circuitry 804 can also implement one or more control loops and/or program logic to generate the signals needed to control various components of the system. For example, HVDC (high voltage DC) side drive signals may be provided to control the operation of switches SuR, SuO, SvO, and SvS depending on the operating mode and other parameters. For example, when charging the low voltage battery from the high voltage battery these switches can be operated to provide a desired voltage to transformer T1 corresponding to a desired battery charging voltage. Control circuitry 804 can also implement burst mode control in light load conditions including balancing as described in greater detail below.

Likewise, control circuitry 804 can also provide LVDC (low voltage DC) side control/drive signals to control the operation of switches Sa/Sa′ and Sb/Sb′ depending on the operating mode and other parameters. For example, these switches can be operated as an active rectifier to produce a DC charging voltage from the AC voltage appearing across the secondary winding of transformer T1. Control circuitry 804 can also implement burst mode charging and associated balancing as described in greater detail below.

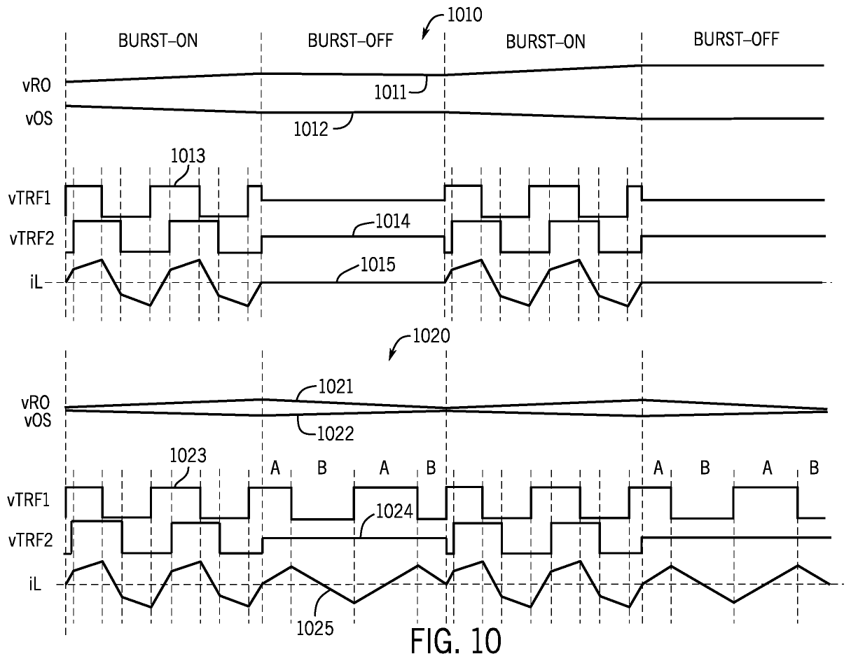

FIGS. 9A-9B illustrate first and second switching modes of a stacked capacitor DC-DC converter operated as a switched capacitor balancer. More specifically, FIG. 9A illustrates a first switching mode (Mode A) 900a, and FIG. 9B illustrates a second switching mode (Mode B) 900b. In both Mode A 900a and Mode B 900b, the low side switches Sa′ and Sb′ of the LFDC side full bridge are turned on. This isolates low voltage battery 203 and output capacitor Co as well as effectively short circuiting the secondary side of the transformer while connecting the blocking capacitance Cp and leakage inductance Llkg across the HVDC side stacked half bridges. This results in the switched capacitor topology described above with respect to FIG. 8A. In Mode A, the high side switches SuR and SvO of the respective HVDC side half bridges are turned on, while the low side switches (SuO, SvS) are turned off. In Mode B, the low side switches SuO, SvS of the HVDC half bridges are turned on while the high side switches SuR, SvO are turned off. Thus, the HVDC side half bridges are both operated with synchronized and complementary duty cycles. Alternating between switching Mode A and Mode B with a fixed frequency enables balancing the input stacked capacitors C1, C2 as explained in greater detail with respect to FIG. 10. This alternation can be considered a first switching sequence (Seq1) corresponding to alternation between Mode A and Mode B (ABABAB), which can also be denoted as Seq1: ABABAB.

FIG. 10 illustrates various waveforms of a stacked capacitor DC-DC converter operated as a switched capacitor balancer using the first and second switching modes. Upper plot 1010 depicts various voltages and currents for burst mode operation in which switching is disabled during the burst off periods. Trace 1011 depicts the voltage vRO between nodes R and O, i.e., the voltage across input capacitor C1. Trace 1012 depicts the voltage vOS between nodes O and S, i.e., the voltage across input capacitor C2. In the illustrated operating sequence, the capacitors become increasingly unbalanced during each burst on interval, represented by the increase in voltage vRO and the decrease in voltage vOS, while the unbalance remains constant, but does not decrease during the burst off intervals. This unbalance situation can be characterized by a shifting midpoint voltage and can be exacerbated by operating conditions in which the burst on intervals are short (e.g., due to very light loading) and/or as a result of hard switching events.

Trace 1013 depicts vTRF1, the voltage applied to the primary winding of the transformer. This voltage alternates between a positive value and a negative value during the burst on periods, corresponding to the commutation of the respective inverter switches. During the burst off periods, vTRF1 is zero (when switching is disabled). Trace 1014 depicts vTRF2, the voltage across the secondary winding of the transformer. This voltage, induced by vTRF1, thus also alternates between a positive and a negative value during the burst on periods. During the burst off periods, vTRF is zero (when switching is disabled). Finally, trace 1015 depicts current iL (through the leakage inductance Llkg) which is quasi-sinusoidal during the burst on intervals and zero during the burst off intervals (when switching is disabled).

Lower plot 1020 depicts various voltages and currents for burst mode operation in which switching as described above with respect to FIGS. 9A-9B is employed during the burst off periods. Trace 1021 depicts the voltage vRO between nodes R and O, i.e., the voltage across input capacitor C1. Trace 1022 depicts the voltage vOS between nodes O and S, i.e., the voltage across input capacitor C2. In the illustrated operating sequence, the capacitors become increasingly unbalanced during each burst on interval, represented by the increase in voltage vRO and decrease in voltage vOS, while the unbalance decreases during the burst off intervals. This is because of the alternation between switching modes A and B as described above, which serves to equalize the input capacitor (C1/C2) voltages (vRO/vOS) by virtue of the flying capacitor operation transferring charge (voltage) from the higher voltage (charge) capacitor to the lower voltage (charge) capacitor via the flying capacitor (blocking capacitor Cp). Additionally, control circuitry 804 can achieve soft switching of the HVDC side switches in equalization mode by suitable control/regulation of the switching frequency with respect to the resonance between flying/blocking capacitor Cp and leakage inductance Llkg.

Trace 1023 depicts vTRF1, the voltage applied to the primary winding of the transformer. This voltage alternates between a positive value and a negative value during the burst on periods, corresponding to the commutation of the respective inverter switches. During the burst off periods, this voltage continues to alternate between positive and negative values by virtue of the control circuitry 804 continuing to operate the switches, alternating between Modes A and B as described above. Thus, switching is no longer disabled during the burst off mode. Trace 1024 depicts vTRF2, the voltage across the secondary winding of the transformer. This voltage, induced by vTRF1, thus also alternates between a positive and a negative value during the burst on periods. During the burst off periods, vTRF2 is again zero because the secondary winding is effectively short circuited, as described above with respect to FIGS. 9A/9B. Finally, trace 1025 depicts current iL (through the leakage inductance Llkg) which is quasi-sinusoidal during the burst on intervals. During the burst off intervals, current iL is again quasi-sinusoidal, although with a DC offset corresponding to the charge transfer between the input capacitors caused by the equalizing operation.

One advantage of the above-described operation can be that closed-loop control may not be needed to balance the HVDC side input capacitors (C1/C2). Control circuitry 804 can simply run the described pulse sequence during burst-off period.

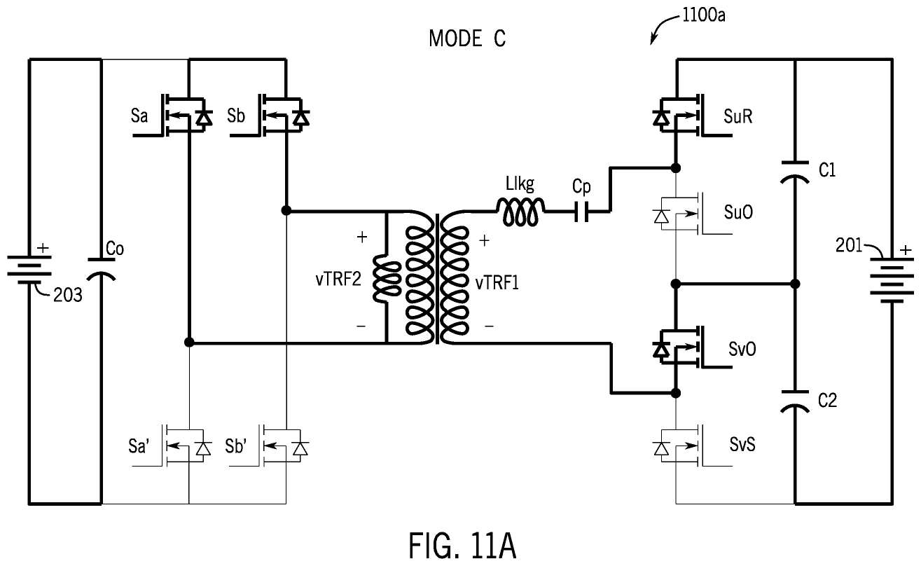

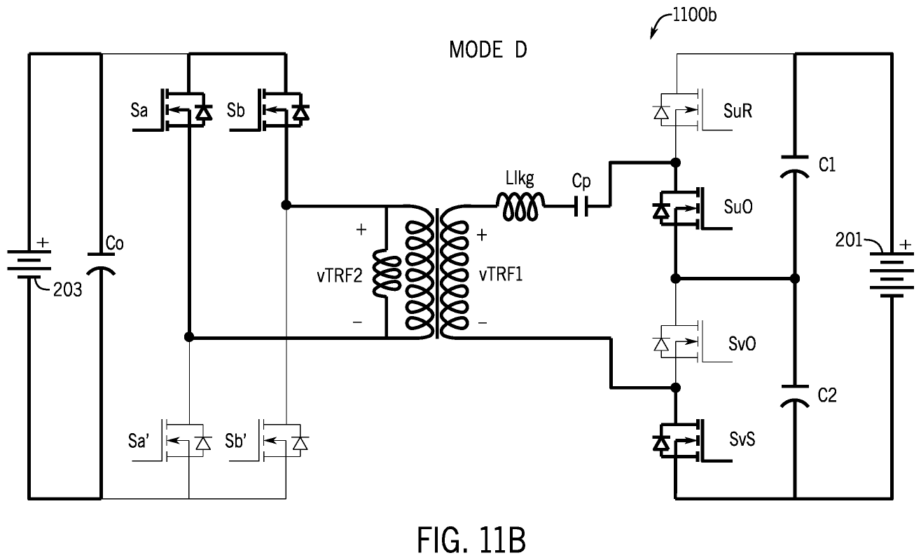

FIGS. 11A-11B illustrate third and fourth switching modes of a stacked capacitor DC-DC converter operated as a switched capacitor balancer. More specifically, FIG. 11A illustrates a third switching mode (Mode C) 1100a, and FIG. 11B illustrates a second switching mode (Mode D) 1100b. These alternate switching modes may be used as an alternative to first Mode A and second Mode B to achieve input balancing. In both Mode C 1100a and Mode D 1100b, the high side switches Sa and Sb of the LVDC side full bridge are turned on. This effectively isolates low voltage battery 203 and output capacitor Co while also effectively short circuiting the secondary winding of the transformer. This also connects the equivalent blocking capacitance Cp and leakage inductance Llkg across the HVDC side stacked half-bridges. This results in the switched capacitor topology described above with respect to FIG. 8A. In Mode C, the high side switches SuR and SvO of the respective HVDC side half bridges are turned on, while the low side switches (SuO, SvS) are turned off (corresponding to Mode A, discussed above). In Mode B, the low side switches SuO, SvS of the HVDC half bridges are turned on while the high side switches SuR, SvO are turned off (corresponding to Mode B, discussed above). Thus, the HVDC side half bridges are both operated with synchronized and complementary duty cycles. Alternating between switching Mode C and Mode D with a fixed frequency enables balancing the input stacked capacitors C1, C2 substantially as explained above with respect to FIG. 10 describing Modes A and B. This alternation can be considered a first switching sequence (Seq2) corresponding to alternation between Mode C and Mode D (CDCDCD), which can also be denoted as Seq2: CDCDCD.

Alternatively, switching sequences can be employed that alternate among Modes A, B, C, and D. In other words, the switching sequence can alternate between LVDC side switches Sa and Sb being constantly on (Modes C/D) and LVDC side switches Sa′ and Sb′ being constantly on (Modes A/B). The frequency of alternating between states on the LVDC side can be equal to or lower than the switching frequency of the HVDC side. Such switching sequences can be beneficial when high side switches do not have dedicated gate drive isolated power supplies and bootstrapping is used (which may require periodically refreshing the high side). Another benefit can be allowing losses and thermal performance to be balanced for all the devices. One example of such a switching sequence (Seq3) is one in which the LVDC side alternation occurs at the same frequency as the HVAC side switching. Thus, Seq3: ADCBADCB. An alternative switching sequence (Seq4) is one in which the DC side alternation occurs at one-half the frequency of the AC side switching. Thus, Seq4: ABCDABCD.

The switching sequences described above with respect to FIGS. 11A-11B can be used to balance the input capacitors C1/C2 substantially as described above with respect to FIG. 11.

The foregoing describes exemplary embodiments of stacked half bridge converters operated as switched capacitor converters for capacitor equalization. Such configurations may be used in a variety of applications but may be particularly advantageous when used in conjunction with various battery charger configurations. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A power conversion system comprising:
at least one stacked half bridge converter including:
a first half bridge further comprising two switching devices in a half bridge configuration and a first capacitor coupled thereacross; and
a second half bridge further comprising two switching devices in a half bridge configuration and a second capacitor coupled thereacross;
wherein the at least one stacked half bridge converter is disposed between an input of the power conversion system and an output of the power conversion system;
a transformer coupled to the at least one stacked half bridge converter by a blocking capacitor; and
control circuitry that operates the switching devices of the at least one stacked half bridge converter as a switched capacitor converter using the blocking capacitor as a flying capacitor to equalize charge between the first and second capacitors.

2. The power conversion system of claim 1 wherein the control circuitry operates the switching devices of the at least one stacked half bridge converter as a switched capacitor converter by alternating between:
one mode including closing high side switches of the first and second half bridges and opening low side switches of the first and second half bridges; and
an additional mode including opening high side switches of the first and second half bridges and closing low side switches of the first and second half bridges.

3. The power conversion system of claim 2 wherein the control circuitry alternates between the one mode and the additional mode at a frequency selected to achieve zero voltage switching by virtue of resonance between a leakage inductance of the transformer with the flying capacitor.

4. The power conversion system of claim 2 wherein at least one stacked half bridge converter includes:
a first stacked half bridge converter coupled between an input of the power conversion system and the transformer; and
a second stacked half bridge converter coupled between the transformer and the battery;
wherein the control circuitry operates the switching devices of the first stacked half bridge converter as the switched capacitor converter using the blocking capacitor as a flying capacitor to equalize charge between the first and second capacitors.

5. The power conversion system of claim 4 wherein the control circuitry opens high side switches of the second stacked half bridge converter and closes low side switches of the second stacked half bridge converter while operating the switching devices of the first stacked half bridge converter as the switched capacitor converter such that the one mode is a first mode and the additional mode is a second mode.

6. The power conversion system of claim 4 wherein the control circuitry closes high side switches of the second stacked half bridge converter and opens low side switches of the second stacked half bridge converter while operating the switching devices of the first stacked half bridge converter as the switched capacitor converter such that the one mode is a third mode and the additional mode is a fourth mode.

7. The power conversion system of claim 4 wherein the control circuitry alternates between:
opening high side switches of the second stacked half bridge converter and closing low side switches of the second stacked half bridge converter while operating the switching devices of the first stacked half bridge converter as the switched capacitor converter such that the one mode is a first mode and the additional mode is a second mode; and
closing high side switches of the second stacked half bridge converter and opening low side switches of the second stacked half bridge converter while operating the switching devices of the first stacked half bridge converter as the switched capacitor converter such that the one mode is a third mode and the additional mode is a fourth mode.

8. The power conversion system of claim 7 wherein the control circuitry alternates between opening high side switches of the second stacked half bridge converter and closing low side switches of the second stacked half bridge converter and closing high side switches of the second stacked half bridge converter and opening low side switches of the second stacked half bridge converter at a frequency equal to a frequency of switching between the one mode and the additional mode.

9. The power conversion system of claim 7 wherein the control circuitry alternates between opening high side switches of the second stacked half bridge converter and closing low side switches of the second stacked half bridge converter and closing high side switches of the second stacked half bridge converter and opening low side switches of the second stacked half bridge converter at a frequency equal to one-half a frequency of switching between the one mode and the additional mode.

10. The power conversion system of claim 2 wherein at least one stacked half bridge converter is coupled between an input of the power conversion system and the transformer and the power conversion system further comprises a full bridge converter coupled between the transformer and the battery.

11. The power conversion system of claim 10 wherein the control circuitry opens high side switches of the full bridge converter and closes low side switches of the full bridge converter while operating the switching devices of the stacked half bridge converter as the switched capacitor converter such that the one mode is a first mode and the additional mode is a second mode.

12. The power conversion system of claim 10 wherein the control circuitry closes high side switches of the full bridge converter and opens low side switches of the full bridge converter while operating the switching devices of the stacked half bridge converter as the switched capacitor converter such that the one mode is a third mode and the additional mode is a fourth mode.

13. The power conversion system of claim 10 wherein the control circuitry alternates between:
opening high side switches of the full bridge converter and closing low side switches of the full bridge converter while operating the switching devices of the stacked half bridge converter as the switched capacitor converter such that the one mode is a first mode and the additional mode is a second mode; and
closing high side switches of the full bridge converter and opening low side switches of the full bridge converter while operating the switching devices of the stacked half bridge converter as the switched capacitor converter such that the one mode is a third mode and the additional mode is a fourth mode.

14. The power conversion system of claim 13 wherein the control circuitry alternates between opening high side switches of the full bridge converter and closing low side switches of the full bridge converter and closing high side switches of the full bridge converter and opening low side switches of the full bridge converter at a frequency equal to a frequency of switching between the one mode and the additional mode.

15. The power conversion system of claim 13 wherein the control circuitry alternates between opening high side switches of the full bridge converter and closing low side switches of the full bridge converter and closing high side switches of the full bridge converter and opening low side switches of the full bridge converter at a frequency equal to one-half a frequency of switching between the one mode and the additional mode.

16. An AC-DC power conversion system comprising:
a first stacked half bridge converter coupled across an AC input of the AC-DC power conversion system, the first stacked half bridge converter further comprising:
a first half bridge including two switching devices in a half bridge configuration and a first capacitor coupled thereacross; and
a second half bridge further comprising two switching devices in a half bridge configuration and a second capacitor coupled thereacross;
a transformer having a primary winding coupled to the first stacked half bridge converter by a blocking capacitor and a secondary winding;
a second stacked half bridge converter coupled between the secondary winding of the transformer and an output of the AC-DC power conversion system, the second stacked half bridge converter further comprising:
a first half bridge further comprising two switching devices in a half bridge configuration and a first capacitor coupled thereacross; and
a second half bridge further comprising two switching devices in a half bridge configuration and a second capacitor coupled thereacross; and
control circuitry that operates the switching devices of the first and second stacked half bridge converters so that the first stacked half bridge converter acts a flying capacitor to equalize charge between the first and second capacitors using the blocking capacitor as a flying capacitor to equalize charge between the first and second capacitors.

17. The AC-DC power conversion system of claim 16 wherein the control circuitry operates the switching devices of the first and second stacked half bridge converters to also equalize charge between third and fourth capacitors using the blocking capacitor as a flying capacitor.

18. The AC-DC power conversion system of claim 16 wherein the control circuitry operates the switching devices of the at least one stacked half bridge converter as a switched capacitor converter by alternating between:
one mode including closing high side switches of the first and second half bridges and opening low side switches of the first and second half bridges of the first stacked half bridge converter; and
an additional mode including opening high side switches of the first and second half bridges and closing low side switches of the first and second half bridges of the first stacked half bridge converter.

19. The AC-DC power conversion system of claim 18 wherein the control circuitry alternates between the one mode and the additional mode at a frequency selected to achieve zero voltage switching by virtue of resonance between a leakage inductance of the transformer with the flying capacitor.

20. The AC-DC power conversion system of claim 18 wherein:
the control circuitry opens high side switches of the second stacked half bridge converter and closes low side switches of the second stacked half bridge converter while operating the switching devices of the first stacked half bridge converter as the switched capacitor converter such that the one mode is a first mode and the additional mode is a second mode; and
the control circuitry closes high side switches of the second stacked half bridge converter and opens low side switches of the second stacked half bridge converter while operating the switching devices of the first stacked half bridge converter as the switched capacitor converter such that the one mode is a third mode and the additional mode is a fourth mode.

21. A DC-DC power conversion system comprising:
a stacked half bridge converter coupled across a DC input of the DC-DC power conversion system, the stacked half bridge converter further comprising:
a first half bridge including two switching devices in a half bridge configuration and a first capacitor coupled thereacross; and
a second half bridge further comprising two switching devices in a half bridge configuration and a second capacitor coupled thereacross;
a transformer having a primary winding coupled to the stacked half bridge converter by a blocking capacitor and a secondary winding;
a full bridge converter coupled between the secondary winding of the transformer and an output of the DC-DC power conversion system, the full bridge converter comprising four switching devices in a full bridge configuration; and
control circuitry that operates the switching devices of the stacked half bridge converter and the full bridge converter so that the stacked half bridge converter acts a switched capacitor converter to equalize charge between the first and second capacitors.

22. The DC-DC power conversion system of claim 21 wherein the control circuitry operates the switching devices of the stacked half bridge converter as a switched capacitor converter by alternating between:
one mode including closing high side switches of the first and second half bridges and opening low side switches of the first and second half bridges; and
an additional mode including opening high side switches of the first and second half bridges and closing low side switches of the first and second half bridges.

23. The DC-DC power conversion system of claim 22 wherein the control circuitry alternates between the one mode and the additional mode at a frequency selected to achieve zero voltage switching by virtue of resonance between a leakage inductance of the transformer with the flying capacitor.

24. The DC-DC power conversion system of claim 22 wherein the control circuitry alternates between:
opening high side switches of the full bridge converter and closing low side switches of the full bridge converter while operating the switching devices of the stacked half bridge converter as the switched capacitor converter such that the one mode is a first mode and the additional mode is a second mode; and
closing high side switches of the full bridge converter and opening low side switches of the full bridge converter while operating the switching devices of the stacked half bridge converter as the switched capacitor converter such that the one mode is a third mode and the additional mode is a fourth mode.
